(19) United States
(12) Patent Application Publication
(10) Pub. No.: US 2008/0141600 A1
(43) Pub. Date: Jun. 19, 2008

(54) MOLDING SYSTEM FOR ACCORDION HURRICANE SHUTTERS

(76) Inventor: Bruce R. Coffey, Deerfield Beach, FL (US)

Correspondence Address: GRAY ROBINSON, P.A., P.O. Box 2328, FT. LAUDERDALE, FL, 33303-9998, US

(21) Appl. No.: 11/610,535

(22) Filed: Dec. 14, 2006

(51) Int. Cl. E06B 3/30

(52) U.S. Cl. 52/204.53

(57) ABSTRACT

This invention is directed to a molding system for use with accordion hurricane shutters which includes a top section, a bottom section, a first side section and a second side section each formed of a foam material such as polyurethane, polystyrene or the like. The sections are mounted to the walls of a building around an opening such as a window or door in a position to hide from view the upper and lower tracks of the accordion shutters, as well as the shutter panels when in the retracted position.

### FIELD OF THE INVENTION

This invention relates to accordion hurricane shutters, and, more particularly, to a molding system for mounting to the top, bottom and sides of an opening in a building in position such that the panels of accordion hurricane shutters, when retracted, and the tracks within which they move, are hidden from view.

### BACKGROUND OF THE INVENTION

The damage to buildings and their contents due to storms, and especially hurricanes, is an ever increasing problem. Doors, windows and other openings in buildings must be secured from wind and rain. Once a door or window of a building is breached, wind can enter the interior of the structure and damage or destroy walls, the roof and other parts of the building.

At least two basic approaches to secure openings in buildings are in general use, particularly in areas prone to hurricanes. One approach is to equip doors and windows in the building with “hurricane-resistant” glass, which generally comprises a combination of plastic vinyl layers and polyester film bonded between panes of glass to form a single sheet. Impacts by flying debris and the like from a storm may shatter the outer pane(s) of glass, but the interior plastic layer(s) generally prevent a breach of the opening. While laminated glass products of this type are effective, they are quite expensive to initially install and must be completely replaced, including the frame for the glass, if damaged.

The most common approach to securing the openings in buildings involves placing a hurricane shutter or plywood over a window, door, etc. to protect against wind, rain and flying debris. There are many types of hurricane shutters, including storm panel shutters, accordion shutters, colonial shutters, bahama-style shutters, roll-down shutters and others. Storm panel shutters come in different forms, but generally comprise a number of corrugated panels formed of metal or plastic which overlap one another and mount within tracks or to bolts affixed to the sides of the window or door opening. Colonial and bahama-style shutters are more aesthetically pleasing, and permanently mount either at the top or along the sides of the opening. Shutters of this type have louvered panels which may be closed, and the shutters secured to the building, during a storm.

Accordion hurricane shutters typically comprise one or two groups of pivotally interconnected panels which are movable between a retracted position at one side of the opening, and an extended position to cover the opening. The top and bottom of each panel includes rollers which are received within upper and lower track assemblies secured to the building at the top and bottom of the opening. If two groups of panels are used, due to the width of the opening, each group of panels is mounted at one side of the opening and they are secured to one another when extended.

Accordion hurricane shutters have the advantage of fast and easy deployment in advance of a storm. Each group of panels may be quickly extended from a retracted to an extended position to cover the opening, and if two panel groups are used they may be easily secured to one another. A problem with this type of shutter arrangement, however, is that the groups of panels and the upper and lower track assemblies, once installed, permanently remain in position about the window or door openings of a building. Even in the retracted position, the panels have a bulky appearance at the sides of the door or window, and the upper and lower tracks are also not aesthetically pleasing. This can greatly detract from the overall appearance of a building, and is unacceptable to many homeowners.

### SUMMARY OF THE INVENTION

This invention is directed to a molding system for use with accordion hurricane shutters which includes a top section, a bottom section, a first side section and a second side section each formed of a foam material such as polyurethane, polystyrene or the like. The sections are secured to the walls of a building around an opening such as a window or door in a position to hide from view the upper and lower tracks of the accordion shutters, as well as the shutter panels when in the retracted position.

In the presently preferred embodiment, both the top section and the bottom section of the molding system have a front surface, a rear surface and an inside surface which rests against one of the upper and lower track assemblies of the accordion shutters. The front surface of the top and bottom sections terminates with a protruding lip, which, when such sections are mounted in position relative to a door or window, hides the upper and lower track assemblies of the accordion shutters from view. The rear surface of each of the top and bottom sections is formed with an elongated slot which receives adhesive for mounting the sections to the wall of the building.

The first and second side sections of the molding system of this invention each comprise a side panel and a front panel. A first edge of each side panel abuts the wall of the building along one side of the opening, and extends outwardly from the wall at substantially a 90° angle. A front panel is affixed to each side panel, along a second edge opposite the first edge, in a position generally parallel to the wall of the building. The front and side panels of each side section therefore collectively form an L-shaped enclosure along each side of the opening in the building within which the panels of the accordion hurricane shutters may be hidden from view when in the retracted position.

### BRIEF DESCRIPTION OF THE DRAWINGS

The structure, operation and advantages of the presently preferred embodiment of this invention will become further apparent upon consideration of the following description, taken in conjunction with the accompanying drawings, wherein:

FIG. 1 is a front view of the molding system of this invention mounted around a window, with one group of shutter panels in the extended position and a second group of shutter panels in the retracted position;

FIG. 2 is a side view, in partial cross section, of the top section and the bottom section of the molding system shown mounted to the wall of a building, and;

FIG. 3 is a partial plan view of the molding system herein depicting the side sections and some of the panels of the accordion shutters.

### DETAILED DESCRIPTION OF THE INVENTION

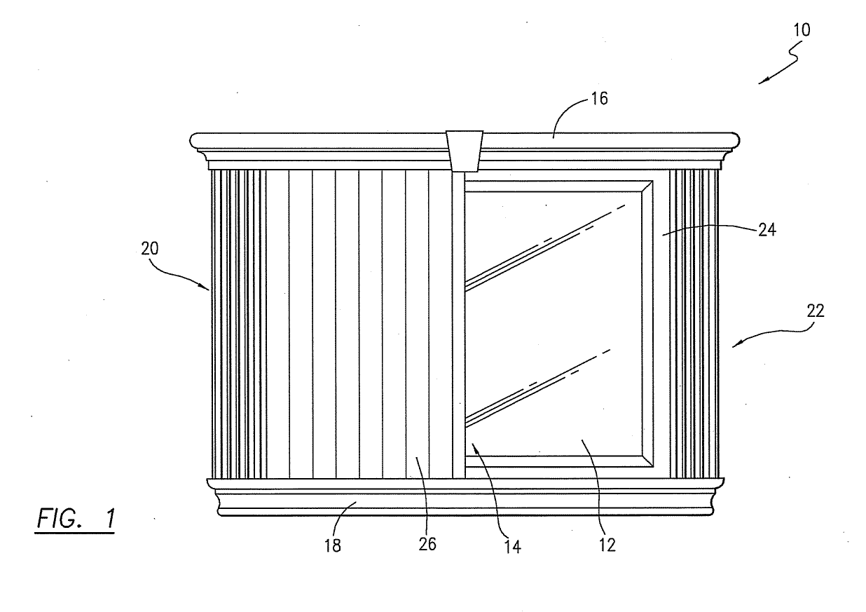

Referring initially to FIG. 1, one embodiment of a molding system 10 according to this invention is shown in an assembled position with respect to a window 12 partially covered by accordion hurricane shutters 14. For purposes of the present discussion, the term “opening” of a building is meant to refer to a window, door or the like which may be covered in a storm to prevent damage to the building. It should be understood that while the molding system 10 is depicted in the Figs. encasing a window 12, it may be used with essentially any opening in a building which may be covered with accordion hurricane shutters 14.

The molding system 10 generally comprises a top section 16, a bottom section 18, a first side section 20 and a second side section 22. Each of the sections 16, 18, 20 and 22 is formed of foam material such as polyurethane, polystyrene or other suitable strong, lightweight and weather resistant foam material. A hard coat and primer may be applied to the foam material, if desired, to improve weather resistance and obtain a desired aesthetic effect. As seen in FIG. 1, the top section 16 extends along the top of the frame 24 of the window 14 and the bottom section 18 is positioned along the bottom or sill of the window frame 24. The first and second side sections 20, 22 are mounted between the top and bottom sections 16, 18 to form an essentially unitary structure. As used herein, the terms “top,” “upper,” “vertical,” “bottom” and “lower” refer to the vertical orientation of the structure in the position depicted in the Figs.

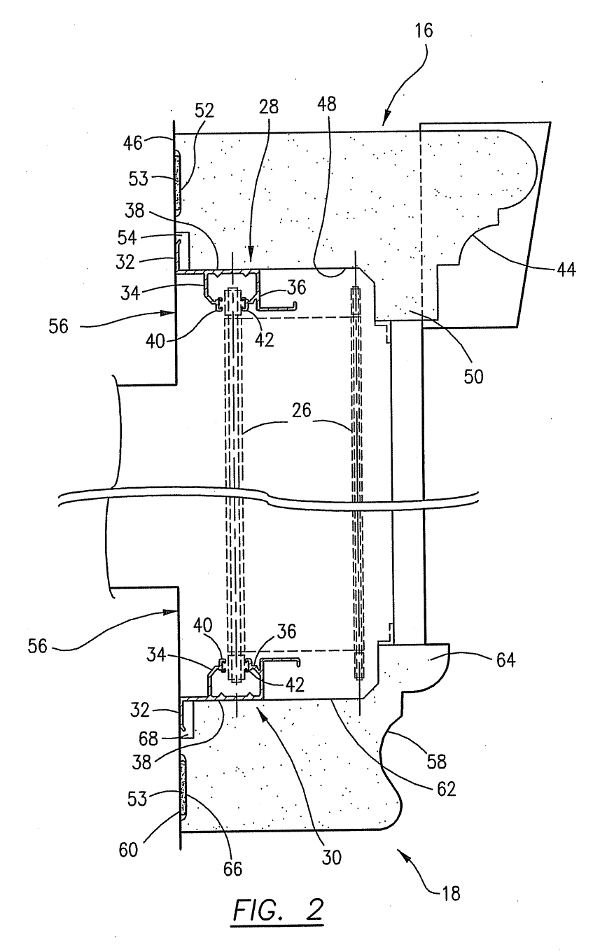

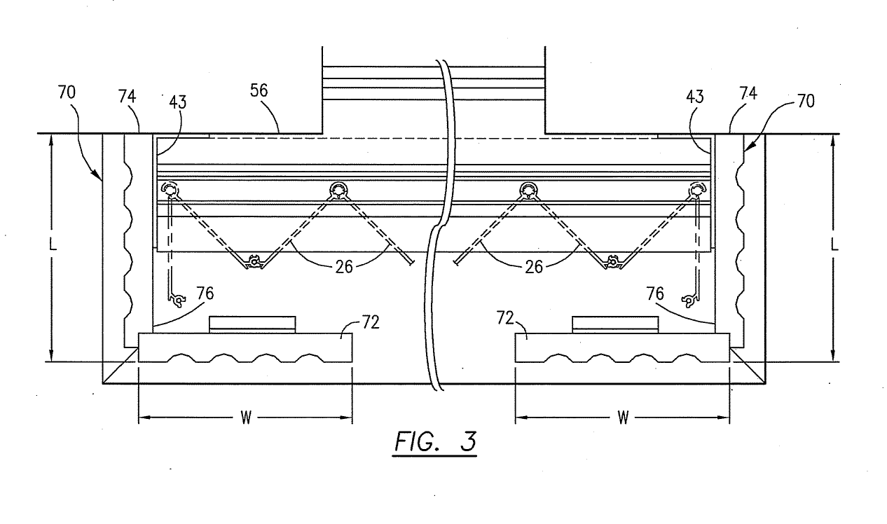

Before discussing the molding system 10 in more detail, a brief description of the accordion shutters 14 is provided. The detailed construction of the accordion shutters 14 forms no part of this invention, and therefore it is only partially described herein. As best seen in FIGS. 2 and 3, the accordion shutters 14 comprise a number of shutter panels 26 pivotally connected to one another along each side edge so that they may be moved between an extended position and a retracted position. Depending upon the overall width of the building opening, one group or two groups of shutter panels 26 may be employed. In the embodiment depicted in the Figs., two groups of shutter panels 26 are needed to cover the width of window 14, one of which is shown in the fully extended position on the left hand side of FIG. 1. The partial, plan view of FIG. 3 illustrates a portion of both groups of shutter panels 26 in a partially extended position.

The shutter panels 26 are movable within an upper track assembly 28 and a lower track assembly 30. Both of the track assemblies 28 and 30 include a rear flange 32 affixed to the building by screws, bolts or the like (not shown) and a pair of opposed track arms 34 and 36. The rear flange 32 and track arms 34, 36 are connected to a plate 38. Rollers 40 and 42 are mounted at the juncture of two shutter panels 26, at both the top and the bottom of the panels 26. The rollers 40 and 42 are received within the track arms 34 and 36, respectively, to permit movement of the shutter panels 26 along the upper and lower track assemblies 28, 30. A side flange 43 is mounted to the building by screws, bolts or the like (not shown) at both sides of the accordion shutters 14 to form a stop which limits the travel of the shutter panels 26 when they are moved to the retracted position.

Referring now to FIG. 2, the top section 16 and bottom section 18 of the molding system 10 are shown in more detail. The top section 16 comprises a front surface 44 formed with contours or other aesthetically pleasing design, a rear surface 46 spaced from the front surface 44 and an inside surface 48 which rests against the plate 38 of the upper track assembly 28. The front surface 44 terminates with an upper lip 50, extending downwardly relative to the inside surface 48. In the presently preferred embodiment, the rear surface 46 of the top section 16 is formed with a slot 52 and a recess 54 each extending substantially along the entire length of the top section 16. The slot 52 receives adhesive 53 which mounts the top section 16 to the building wall 56, as schematically depicted in FIG. 2. The recess 54 receives the rear flange 32 of the upper track assembly 28 so as to avoid interference between the rear flange 32 and top section 16, thus allowing the rear surface 46 to rest flush against the wall 56.

The bottom section 18 has a construction similar to the top section 16. The bottom section 18 includes a front surface 58 formed with contours or other aesthetically pleasing design, a rear surface 60 spaced from the front surface 58 and an inside surface 62 which rests against the plate 38 of the lower track assembly 30. The front surface 58 terminates with a lower lip 64, extending downwardly relative to the inside surface 62. In the presently preferred embodiment, the rear surface 60 of the bottom section 18 is formed with a slot 66 and a recess 68 each extending substantially along the entire length of the bottom section 18. The slot 66 receives adhesive 53 which mounts the bottom section 18 to the building wall 56, as schematically depicted in FIG. 2. The recess 68 receives the rear flange 32 of the lower track assembly 30 so as to avoid interference between the rear flange 32 and bottom section 18, thus allowing the rear surface 60 to rest flush against the wall 56.

As seen in FIGS. 1 and 2, the vertical dimension of the upper lip 50 of top section 16 and the vertical dimension of the lower lip 64 of bottom section 18 are such that when the window 14 is viewed from the front, as in FIG. 1, the upper track assembly 28 is hidden from view by the upper lip 50 and the lower track assembly 30 is hidden from view by the lower lip 64. Not only are the top and bottom sections 16, 18 aesthetically pleasing due to their contoured front surfaces 44, 58, but the unsightly track assemblies 28 and 30 are covered from view at all times.

Referring now to FIGS. 1 and 3, the first and second side sections 20 and 22 of the molding system 10 are shown in detail. The side sections 20, 22 have the same construction and therefore the same reference numbers are used in the Figs. to identify like structure. Each side section 20 and 22 comprises a side panel 70 and a front panel 72, both of which extend between the top and bottom sections 16, 18 on either side of the window frame 24. One edge 74 of the side panel 70 abuts the building wall 56, and a portion of its inside face 76 extends along the side flange 43 of the accordion shutters 14 where it may be mounted thereto by adhesive or any other suitable fastening means. The opposite edge of the side panel 70 is connected to the front panel 72. The front panel 72 is oriented substantially perpendicularly relative to the side panel 70 and parallel to the building wall 56. The side panel 70 and front panel 72 therefore collectively form an L-shaped enclosure along each side of the window frame 24 having a length dimension defined by the length “L” of the side panel 70 and a width dimension “W” defined by the width of the front panel 72. These length L and width W dimensions of the side and front panels 70, 72 are chosen to completely hide the shutter panels 26 located on either side of the window 14, when viewed both from the front as in FIG. 1 or from the side of the window 14 as in FIG. 3.

The molding system 10 of this invention therefore provides a visually pleasing covering for the shutter panels 26 and upper and lower track assemblies 28, 30 of the accordion hurricane shutters 14, which is inexpensive, durable and easy to install.

While the invention has been described with reference to a preferred embodiment, it should be understood by those skilled in the art that various changes may be made and equivalents substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A molding system for use with accordion storm shutters which include a number of shutter panels movable between a retracted position at one side of an opening in a building and an extended position substantially covering the opening along an upper track assembly and a lower track assembly each secured by a flange to the building, said molding system comprising:
a top section, a bottom section, a first side section and second side section each formed of a foam material;
said top section being adapted to extend along the top of the opening in the building, said top section having a front surface, a spaced rear surface and an inside surface adapted to rest against the upper track assembly, said front surface terminating with an upper lip which extends outwardly relative to said inside surface so that with said top section positioned along the top of the opening in the building the upper track assembly is hidden from view;
said bottom section being adapted to extend along the bottom of the opening in the building, said bottom section having a front surface, a spaced rear surface and an inside surface adapted to rest against the lower track assembly, said front surface terminating with a lower lip which extends outwardly relative to said inside surface so that with said bottom section positioned along the bottom of the opening in the building the lower track assembly is hidden from view;
each of said first and second side sections being adapted to extend between said top and bottom sections along one side of the opening in the building, each of said first and second side sections including a side panel adapted to abut the building and a front panel connected to said side panel, said side panel having a length direction measured in a direction substantially perpendicular to the wall of the building and said front panel having a width dimension measured in a direction substantially parallel to the wall of the building such that with said first and second sections positioned along one side of the opening in the building the shutter panels, when in the retracted position, are hidden from view.

2. The molding system of claim 1 in which said rear surface of said top section is formed with a slot, said slot being adapted to receive adhesive for mounting said top section to the building.

3. The molding system of claim 1 in which said rear surface of said top section is formed with a recess, said recess being adapted to receive the flange of the upper track assembly to permit mounting of said rear surface flush against the wall of the building.

4. The molding system of claim 1 in which said rear surface of said bottom section is formed with a slot, said slot being adapted to receive adhesive for mounting said bottom section to the building.

5. The molding system of claim 1 in which said rear surface of said bottom section is formed with a recess, said recess being adapted to receive the flange of the lower track assembly to permit mounting of said rear surface flush against the wall of the building.

6. The molding system of claim 1 in which said front surface of each of said top section and said bottom section is formed with a contoured shape.

7. The molding system of claim 7 in which said front panel of each of said first and second side sections is connected perpendicularly to said side panel thereof.

8. The molding system of claim 1 in which said, side panel of each of said first and second side sections has an inside surface, at least a portion of said inside surface being adapted to connect to a side flange mounted to the wall of the building in position to prevent disengagement of the shutter panels from the upper and lower track assemblies.
